(19) United States
(12) Patent Application Publication
(10) Pub. No.: US 2024/0121479 A1
(43) Pub. Date: Apr. 11, 2024

(54) MULTIMEDIA PROCESSING METHOD, APPARATUS, DEVICE, AND MEDIUM

(71) Applicant: Beijing Zitiao Network Technology Co., Ltd., Beijing (CN)

(72) Inventors: Kojung CHEN, Beijing (CN); Yinuo ZHOU, Beijing (CN); Biao GONG, Beijing (CN); Jingsheng YANG, Beijing (CN); Tian ZHAO, Beijing (CN); Jinghui LIU, Beijing (CN); Daqian LU, Beijing (CN); Yao YANG, Beijing (CN); Tao CHENG, Beijing (CN); Zaofeng PAN, Beijing (CN); Tianhui SHI, Beijing (CN); Rongyi TANG, Beijing (CN); Guodong GONG, Beijing (CN)

(21) Appl. No.: 18/262,301

(22) PCT Filed: Apr. 7, 2022
(86) PCT No.: PCT/CN2022/085468

§ 371 Date: Jul. 20, 2023

(30) Foreign Application Priority Data
May 19, 2021 (CN) 202110547916.9

(51) Int. Cl. H04N 21/472; H04N 21/431; H04N 21/488

(52) U.S. Cl. CPC H04N 21/47217; H04N 21/4312; H04N 21/4884

(57) ABSTRACT

Embodiments of the present disclosure relate to multimedia processing method, apparatus, device and medium, wherein the method includes: presenting a first multimedia interface comprising first content; receiving an interface switching request of a user in the first multimedia interface; and switching from the first multimedia interface currently presented to a second multimedia interface, and presenting second content in the second multimedia interface, wherein the first content comprises the second content and other content associated with the second content, and the second content comprises a target audio and a target subtitle corresponding to the target audio.

The present disclosure claims priority to Chinese Patent Application No. 202110547916.9, filed on May 19, 2021 and entitled “MULTIMEDIA PROCESSING METHOD, APPARATUS, DEVICE, AND MEDIUM”, the disclosure of which is incorporated by reference herein in its entirety.

### TECHNICAL FIELD

The present disclosure relates to the field of multimedia technologies, and in particular, to multimedia processing method, apparatus, device, and medium.

### BACKGROUND

With the continuous development of smart devices and multimedia technologies, information recording by smart devices is increasingly applied in daily life and office life.

In some related products, multimedia files for information recording may be played back for review again. At present, the manner of playing back the multimedia files is relatively fixed, single and low in flexibility.

### SUMMARY

To solve the above technical problems, or at least partially solve the above technical problems, the present disclosure provides multimedia processing method, apparatus, device, and medium.

Embodiments of the present disclosure provide a multimedia processing method, comprising: presenting a first multimedia interface comprising first content; receiving an interface switching request of a user in the first multimedia interface; and switching from the first multimedia interface currently presented to a second multimedia interface, and presenting second content in the second multimedia interface, wherein the first content comprises the second content and other content associated with the second content, and the second content comprises a target audio and a target subtitle corresponding to the target audio.

Embodiments of the present disclosure further provide a multimedia processing apparatus, comprising: a first interface module configured to present a first multimedia interface comprising first content; a request module configured to receive an interface switching request of a user in the first multimedia interface; and a second interface module configured to switch from the first multimedia interface currently presented to a second multimedia interface and present second content in the second multimedia interface, wherein the first content comprises the second content and other content associated with the second content, and the second content comprises a target audio and a target subtitle corresponding to the target audio.

Embodiments of the present disclosure further provide an electronic device, comprising: a processor; and a memory configured to store instructions executable by the processor, wherein the processor is configured to read the instructions from the memory and execute the instructions to implement a multimedia processing method according to embodiments of the present disclosure.

Embodiments of the present disclosure further provide a computer-readable storage medium, having stored thereon a computer program for performing a multimedia processing method according to embodiments of the present disclosure.

Embodiments of the present disclosure further provide a computer program comprising instructions, which when executed by a processor, cause the processor to perform a multimedia processing method according to embodiments of the present disclosure.

Embodiments of the present disclosure further provide a computer program product comprising instructions, which when executed by a processor, cause the processor to perform a multimedia processing method according to embodiments of the present disclosure.

### BRIEF DESCRIPTION OF THE DRAWINGS

The above and other features, advantages, and aspects of embodiments of the present disclosure will become more apparent by referring to the following detailed description in conjunction with the accompanying drawings. Throughout the drawings, the same or similar reference numbers refer to the same or similar elements. It should be understood that the drawings are illustrative and that elements and components are not necessarily drawn to scale.

FIG. 1 is an illustrative flow diagram of a multimedia processing method according to embodiments of the present disclosure;

FIG. 2 is an illustrative flow diagram of another multimedia processing method according to embodiments of the present disclosure;

FIG. 3 is an illustrative diagram of a multimedia interface according to embodiments of the present disclosure;

FIG. 4 is an illustrative diagram of another multimedia interface according to embodiments of the present disclosure;

FIG. 5 is an illustrative diagram of a floating window component according to embodiments of the present disclosure;

FIG. 6 is an illustrative structural diagram of a multimedia processing apparatus according to embodiments of the present disclosure; and

FIG. 7 is an illustrative structural diagram of an electronic device according to embodiments of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, but rather these embodiments are provided for a more complete and thorough understanding of the present disclosure. It should be understood that the drawings and the embodiments of the present disclosure are for illustration purposes only and are not intended to limit the scope of protection of the present disclosure.

It should be understood that various steps recited in method of embodiments of the present disclosure may be performed in a different order, and/or performed in parallel. Moreover, the method of embodiments may comprise additional steps and/or omit the illustrated steps. The scope of the present disclosure is not limited in this respect.

The term “comprising” and variations thereof used herein is intended to be non-exclusive, i.e., “comprising but not limited to”. The term “based on” means “at least partially based on”. The term “one embodiment” means “at least one embodiment”; the term “another embodiment” means “at least one other embodiment”; the term “some embodiments” means “at least some embodiments”. Relevant definitions for other terms will be given in the following description.

It should be noted that the concepts such as “first” and “second” mentioned in the present disclosure are only used for distinguishing different devices, modules or units, but are not used for limiting the order or interdependence of functions performed by the devices, modules or units.

It should be noted that the modifications of “one” or “more” mentioned in the present disclosure are intended to be illustrative rather than restrictive, and that those skilled in the art should appreciate that they should be understood as “one or more” unless otherwise clearly stated in the context.

Names of messages or information exchanged between a plurality of devices in the embodiments of the present disclosure are for illustrative purposes only, and are not intended to limit the scope of the messages or information.

Compared with related art, the technical solutions according to embodiments of the present disclosure have the following advantages: the multimedia processing solution according to embodiments of the present disclosure presents a first multimedia interface comprising first content; receives an interface switching request of a user in the first multimedia interface; and switches from the first multimedia interface currently presented to a second multimedia interface, and presents second content in the second multimedia interface, wherein the first content comprises the second content and other content associated with the second content, and the second content comprises a target audio and a target subtitle corresponding to the target audio. By adopting the above technical solution, the switching of interfaces comprising two different contents can be realized, wherein one of the interfaces may comprise only audio and subtitle, which helps the user to concentrate on the multimedia content in a complex scene, and improves flexibility of playing the multimedia content, meet the requirements of various scenes, and further improves the experience effect of the user.

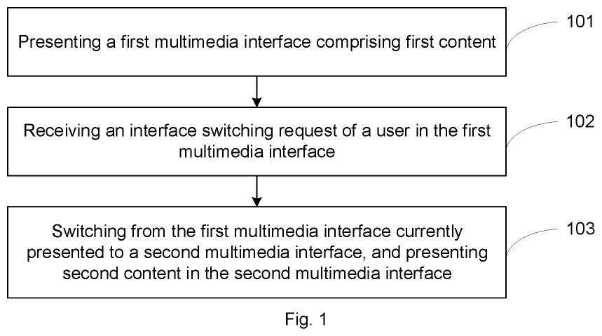

FIG. 1 is an illustrative flow diagram of a multimedia processing method according to embodiments of the present disclosure. The method may be performed by a multimedia processing apparatus. The apparatus may be implemented by software and/or hardware, and may be generally integrated in an electronic device. As shown in FIG. 1, the method comprises various steps.

At step 101, presenting a first multimedia interface comprising first content.

Multimedia interface refers to an interface for presenting various types of multimedia information, which may include audio, video, text, and the like, without limitation. The first multimedia interface refers to one of multimedia interfaces. The first content refers to content presented in the first multimedia interface and may include various multimedia information. For example, in a conference recording scene, the first content may include content related to the conference, such as recorded/drawn audio and/or video, corresponding subtitle content, and conference summary.

In embodiments of the present disclosure, a client may acquire the first content according to a request of a user, present the first multimedia interface, and present the first content in the first multimedia interface. Since the first content may include multiple types of information, different presentation areas may be arranged in the first multimedia interface for presenting the various types of information. For example, an audio video area, a subtitle area, a summary presenting area, and other areas may be arranged in the first multimedia interface, respectively for presenting audio, video, subtitle content, summary, and the like.

At step 102, receiving an interface switching request of a user in the first multimedia interface. The interface switching request refers to a request for switching between different interfaces.

In embodiments of the present disclosure, after the first multimedia interface is presented, a trigger operation of a user on the first media interface may be detected. After a trigger operation of the user on an interface switching button being detected, it may be determined that an interface switching request is received. The interface switching button can be a virtual button preset in the first multimedia interface, whose specific position and form are not limited.

At step 103, switching from the first multimedia interface currently presented to a second multimedia interface, and presenting second content in the second multimedia interface.

The second multimedia interface is a multimedia interface for presenting content different from the first multimedia interface. The first content presented in the first multimedia interface may include the second content and other content associated with the second content. That is, the second content may be a part of the first content of the first multimedia interface. The second content may include a target audio and a target subtitle corresponding to the target audio. The target audio may be audio data of any recorded information. For example, the target audio may be audio data in a conference recording process. The target subtitle refers to text content obtained after the target audio is recognized and processed by using an Automatic Speech Recognition (ASR) technology. The specific speech recognition technology is not limited in embodiments of the present disclosure. For example, a random model method or an artificial neural network method may be adopted.

In embodiments of the present disclosure, after receiving the interface switching request, the currently presented first multimedia interface may be closed and the second multimedia interface may be opened, and the second content may be presented in the second multimedia interface, thereby implementing the interface switching. Since only audio and subtitle are included in the second multimedia interface, it can help the user concentrate on multimedia content in complex scenes.

It can be understood that after the second content being presented in the second multimedia interface, the first multimedia interface can be returned to based on a trigger operation of the user on an exit button in the second multimedia interface, so that flexible switching of the multimedia interfaces of two different modes is realized, and the user can switch according to actual needs. After returning to presenting the first multimedia interface, a floating window component of the second multimedia interface can be presented so that the user can quickly switch back to the second multimedia interface. In the floating window component of the second multimedia interface, the target audio can continue to be played. After the user triggers the floating window component of the second multimedia interface, the second multimedia interface can be returned to for presentation.

The multimedia processing solution according to embodiments of the present disclosure presents a first multimedia interface comprising first content; receiving an interface switching request of a user in the first multimedia interface; and switching from the first multimedia interface currently presented to a second multimedia interface, and presenting second content in the second multimedia interface, wherein the first content comprises second content and other content associated with the second content, and the second content comprises a target audio and a target subtitle corresponding to the target audio. By adopting the above technical solution, switching of interfaces comprising two different contents can be realized, wherein one of the interfaces may comprise only audio and subtitle, which helps the user to concentrate on multimedia content in complex scenes. In addition, the multimedia content is played in various forms (for example, played in the first multimedia interface and played in the second multimedia interface), so that flexibility of playing the multimedia content is improved, the requirements of various scenes can be met, and the experience effect of the user is improved.

In some embodiments, the multimedia processing method may further comprise: receiving a play trigger operation on the target audio; playing the target audio, and emphasizing a subtitle sentence included in the target subtitle corresponding to a playing progress of the target audio during playing the target audio, based on a timestamp of subtitle sentence.

The play trigger operation refers to a trigger operation for playing multimedia, and a specific form of the play trigger operation may be various, and is not limited specifically. The target subtitle belongs to structured text comprising a three-layer structure of paragraph, sentence, and word. The subtitle sentence is a sentence in the target subtitle, and one subtitle sentence may comprise at least one character or word. Since the target subtitle is obtained by performing speech recognition on the target audio, each subtitle sentence has a corresponding speech sentence, and each speech sentence corresponds to a timestamp in the target audio. The target subtitle can be obtained after the target audio is subjected to speech recognition. For each subtitle sentence in the target subtitle, its corresponding speech sentence in the target audio can be determined. Since each speech sentence corresponds to a playing time of the target audio, the timestamp of each subtitle sentence in the target subtitle can be determined according to a correspondence between the speech sentence and the playing time of the target audio. The emphasizing is not specifically limited in embodiments of the present disclosure, for example, the emphasizing may be performed by one or more of highlighting, bolding, increasing display size, changing display font, adding underlines, etc.

Specifically, after a trigger operation of a user for playing the target audio is received, the target audio can be played. During playing the target audio, subtitle sentences corresponding to the playing progress are emphasized in sequence according to timestamps of the subtitle sentences included in the target subtitle. That is, as the target audio is played, the subtitle sentences in the target subtitle are emphasized in sequence as the playing progresses.

In the above solution, the corresponding subtitle sentences can also be emphasized in association with the audio playing process, and association interaction between multimedia and subtitles can be realized, so that a user can better know the multimedia content, and the experience effect of the user is improved.

In some embodiments, the multimedia processing method may further comprise: in response to an end of playing the target audio, acquiring a next audio associated with the target audio, and switching to playing the next audio. Here, the end of playing the target audio may be determined based on an operation of the user, or the end of playing the target audio may be determined based on a playing progress of the target audio reaching a playing completion timing.

The next audio refers to a preset audio associated with attribute information of the target audio. The attribute information is not limited, for example, the attribute information may be time, user or other critical information. For example, when the target audio is a recorded audio of a conference, the next audio may be the following conference audio adjacent to the end timing of the conference. Specifically, at the end of playing the target video, the next audio associated with the target audio may be determined, and the next audio may be acquired and played. Alternatively, the next audio may be the next audio in the playlist determined based on attribute value(s) of one or more items of attribute information. For example, if the attribute information includes a conference date, the user may determine a playlist based on the conference date. Thus, at the end of playing the target audio in the playlist, the next audio is continued to be played. This has an advantage that, the next audio can be seamlessly played at the end of playing the current audio, so that a user can know more related contents, an abrupt feeling caused by a stop is avoided, and the multimedia information playback experience is improved.

In some embodiments, the multimedia processing method may further comprise: determining a non-silent segment in the target audio; and playing the target audio comprises: only playing the non-silent segment while the target audio is played. In some embodiments, the multimedia processing method may further comprise: determining a silent segment and a non-silent segment in the target audio; and playing the target audio comprises: playing the silent segment at a first playing speed, and playing the non-silent segment at a second playing speed, wherein the first playing speed is greater than the second playing speed.

The silent segment refers to an audio segment with zero volume in the target audio, and the non-silent segment refers to an audio segment with non-zero volume in the target audio. Specifically, by recognizing a volume of the target audio, the non-silent segments in the target audio can be determined, and only the non-silent segment is played when the target audio is played. Alternatively, the silent segment and the non-silent segment of the target audio may be determined through volume recognition, and the silent segment is played at a first playing speed, and the non-silent segment is played at a second playing speed. The first playing speed and the second playing speed can be determined according to actual situations as long as the first playing speed is greater than the second playing speed, for example, the first playing speed can be set to be twice as high as the second playing speed.

In the above solution, when the audio is played, the silent segment can be skipped, and only the critical content is played. Alternatively, the silent segment and the non-silent segment can be played at two different speeds. Both manners can improve the speed of the user for knowing the audio content and improve flexibility of the audio playing.

In some embodiments, the multimedia processing method may further comprise: receiving an interactive trigger operation of the user in the second multimedia interface; and determining interactive content based on the interactive trigger operation. Alternatively, determining interactive content based on the interactive trigger operation comprises: in response to the interactive trigger operation, presenting an interactive component in the second multimedia interface; acquiring the interactive content based on the interactive component, and presenting the interactive content in the second multimedia interface; wherein the interactive component comprises an emoticon component and/or a comment component, and the interactive content comprises an interactive emoticon and/or comment. Alternatively, the multimedia processing method may further comprise: presenting the interactive content in the first multimedia interface.

The interactive input trigger operation refers to a trigger operation that a user wants to perform interactive input on current multimedia content. In embodiments of the present disclosure, the interactive input trigger operation may comprise a trigger operation on a playing time axis of the target audio in the second multimedia interface or on an interactive button. The interactive button may be a button preset in the second multimedia interface, and a specific position and style of the button are not limited. The interactive component refers to a functional component for performing operations such as interactive content input, editing, and publishing. The interactive component may comprise an emoticon component and/or a comment component. The emoticon component is a functional component for inputting emoticons, and may include a set number of emoticons. The set number may be set according to an actual situation, for example, the set number may be 5. The emoticons can include like, love, various emotional emoticons and the like, which are not limited specifically.

Specifically, after receiving the interactive trigger operation of the user in the second multimedia interface, the interactive component may be presented to the user. An emoticon component and/or a comment component is presented in the interactive component. An interactive emoticon selected by the user in the emoticon component may be acquired. A comment inputted by the user in the comment component may also be acquired. The interactive emoticon and/or the comment are presented in the second multimedia interface, but specific positions for presentation are not limited. Alternatively, the interactive emoticon and/or the comment may also be presented in the first multimedia interface, but specific positions for presentation are not limited.

In the above solution, the interaction of the user is also supported while the multimedia content is presented on the multimedia interface, and the interactive content can be presented in the first multimedia interface and/or the second multimedia interface, so that a participation experience effect of the user is improved.

In some embodiments, the multimedia processing method may further comprise: determining an interaction time point corresponding to the interactive input trigger operation; and presenting an interactive prompt identification at a position of the interaction time point, on a playing time axis of the target audio in the second multimedia interface and/or the first multimedia interface. The interaction time point refers to a corresponding time point in the target audio when the user performs the interactive input trigger operation. The interactive prompt identification is a prompt identification for reminding a user of the existence of interactive content, and the interactive prompt identifications corresponding to different interactive contents may be different. For example, the interactive prompt identification corresponding to an emoticon may be the emoticon itself, and the interactive prompt identification corresponding to a comment may be a set dialog identification.

After receiving the interactive input trigger operation of the user, a real timing of the interactive input trigger operation can be determined. The playing time point of the target audio at the real timing can be determined as the interaction time point. Thereafter, the interactive prompt identification corresponding to the interactive content can be presented on the playing time axis of the target audio in the second multimedia interface and/or the first multimedia interface, so as to prompt the user that here is interactive content. When one time point on the playing time axis comprises a plurality of interactive contents, the corresponding interactive prompt identifications can be overlapped for presentation.

In the above solution, after the user inputs the interactive content, the prompt identification of the interactive content can be presented on the playing time axes of the two multimedia interfaces, so that the contents presented on the two multimedia interfaces are synchronized, and other users are prompted that here is the interactive content, such that the user's interaction is not limited to only himself, the interaction mode is more diversified, and the interaction experience of the user is further improved.

In some embodiments, the multimedia processing method may further comprise: receiving a modification operation on the target subtitle presented in the first multimedia interface; and synchronously modifying the target subtitle presented in the second multimedia interface. After the user modifies at least one of characters, words or sentences in the presented target subtitle in the first multimedia interface, the modified target subtitle can be presented in the first multimedia interface; and simultaneously, the target subtitle presented in the second multimedia interface is synchronously modified, and the modified target subtitle is presented. In the above solution, for the contents presented in the two multimedia interfaces, after the content in one multimedia interface is modified, the content in the other multimedia interface can also be modified synchronously, so that errors are avoided when the user views the same content in different multimedia interfaces.

In some embodiments, the first multimedia interface and the second multimedia interface are both interfaces of a first application, and the multimedia processing method may further comprise: receiving an application switching request; switching the first application to background running, and launching a second application, presenting a presentation interface of the second application; and presenting a floating window component of the second multimedia interface in the presentation interface of the second application.

The second application may be any application different from the first application. For example, the first application and the second application are two different functional modules of the same application, or two different applications, respectively. The floating window component can be an entry component for quickly returning to the second multimedia interface in the first application, that is, the first application can be quickly switched from background running to foreground running through the floating window component. Moreover, a specific form of the floating window component is not limited, for example, the floating window component can be a round or square presentation small window.

Specifically, the application switching request may be received based on a trigger operation of the user, and then the first application may be switched to background running and the second application is started, so as to present the presentation interface of the second application, where the presentation interface of the second application may present the floating window component of the second multimedia interface in addition to related content of the second application. The floating window component can be floating on an uppermost layer of the presentation interface of the second application, so that the user can trigger the floating window component when operating the current presentation interface. A specific position of the floating window component in the presentation interface of the second application can be set according to actual conditions, for example, the floating window component can be presented at any position where the currently displayed content is not shielded.

Alternatively, the floating window component includes a cover picture and/or playing information of the target audio. Alternatively, the playing information includes a playing progress; the cover picture and the playing progress are presented in association. Alternatively, there are a plurality of the cover pictures, and the cover picture varies with the playing progress. Alternatively, the playing progress is displayed around the cover picture. Alternatively, the cover picture is determined based on the first content.

The floating window component may include information related to the target audio, for example, the floating window component may include a cover picture and/or playing information, and the playing information may include a playing progress, a playing time point, and the like. The cover picture may be determined according to the first content comprised in the first multimedia interface, for example, when the first content includes a video corresponding to the target audio, a screenshot may be taken out of the video as the cover picture. The cover picture can also be associated with the playing progress for presentation, and in a specific presentation, when there are a plurality of the cover pictures, the cover pictures can be changed with the playing progress, that is, as the playing progress changes, the cover picture that the current playing progress corresponds is presented in real time. In addition, the playing progress can also be presented around the cover picture, which is only an example.

In the above solution, by presenting the pictures of the target audio or related information such as the playing information in the floating window component, the user can also know the playing condition of the audio when operating other applications, and the audio playing effect is further improved.

Alternatively, the multimedia processing method may further comprise: receiving a trigger operation on the floating window component, switching the first application from background running to foreground running, and returning to presenting the second multimedia interface. After a clicking operation of the user on the floating window component is received, the current second application can be switched to background running, and the first application can be switched from background running to foreground running, to present the second multimedia interface.

Alternatively, if the target audio is playing before receiving the application switching request, the multimedia processing method may further comprise: continuing playing the target audio based on the floating window component. If the target audio is playing after receiving the application switching request and presenting the floating window component in the presentation interface of the second application, the target audio can be continued to be played based on the floating window component, for the purpose of seamless playing of the audio.

In the above solution, on the basis of the presentation of the multimedia interface, the floating window component of the multimedia interface can also be presented after being switched to other applications, the multimedia interface can be quickly returned to through the floating window component, the audio data can be continuously played and the playing condition can be presented, so that the efficiency of returning to the multimedia interface is improved, the requirements of the user can be well met, and the experience effect of the user is improved.

In some embodiments, the multimedia processing method may further comprise: in response to an interface switching request of the user in a currently presented third multimedia interface, switching the currently presented third multimedia interface into the second multimedia interface; wherein the third multimedia interface comprises third content, and the third content comprises attribute information of the second content. Alternatively, the attribute information of the second content comprises at least one of title information, time information, or source information of the second content.

The third multimedia interface is a multimedia interface that presents different contents from the first multimedia interface and the second multimedia interface. Third content comprised in the third multimedia interface has an association with the second content, and may comprise attribute information of the second content, and the attribute information of the second content may be determined according to an actual situation, and for example, the attribute information may comprise at least one of title information, time information, and source information etc. of the second content. Illustratively, the third multimedia interface may be an interface including an information list, where the information list includes attribute information of multiple audios, and one of them is attribute information of the target audio. The terminal presents the third multimedia interface, and after receiving an interface switching request of the user in the third multimedia interface, the terminal can close the currently presented third multimedia interface and open the second multimedia interface, and present the second content in the second multimedia interface to realize interface switching.

In the above solution, by means of the switching operation of the two multimedia interfaces that present different contents, the multimedia interface only comprising audio and subtitle can be switched to, so that the switching flexibility of the multimedia interfaces in different modes is further improved, and the interface switching efficiency of the user is improved.

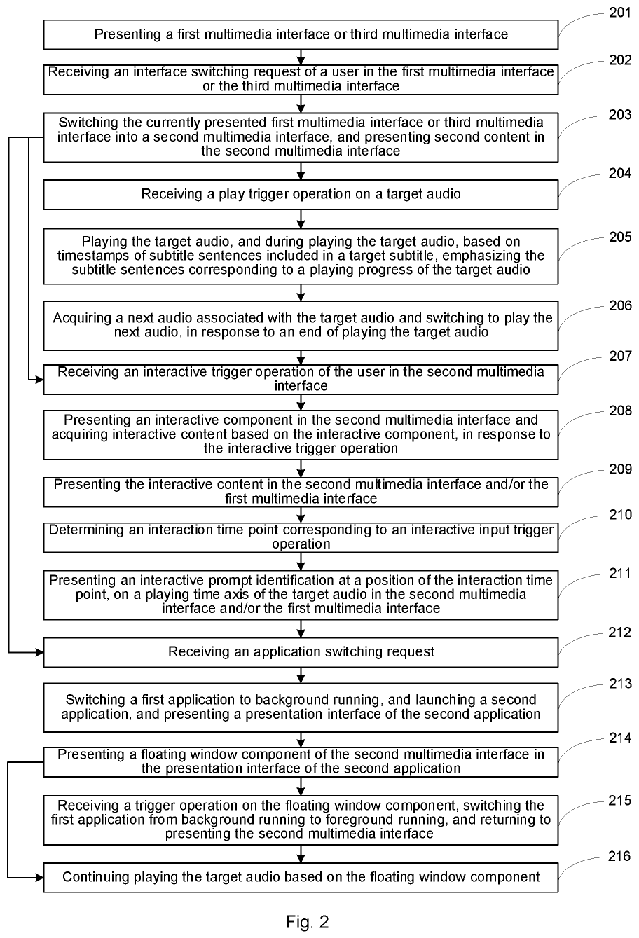

FIG. 2 is an illustrative flow diagram of another multimedia processing method according to embodiments of the present disclosure, and the present embodiment further optimizes the multimedia processing method on the basis of the above embodiment. As shown in FIG. 2, the method comprises the following steps.

At step 201, presenting a first multimedia interface or a third multimedia interface. The first multimedia interface comprises first content, and the third multimedia interface comprises third content.

At step 202, receiving an interface switching request of a user in the first multimedia interface or the third multimedia interface.

At step 203, switching from the currently presented first multimedia interface or third multimedia interface to a second multimedia interface, and presenting second content in the second multimedia interface.

The first content comprises the second content and other content associated with the second content, and the second content comprises a target audio and a target subtitle corresponding to the target audio. The third content comprises attribute information of the second content, and the attribute information of the second content comprises at least one of title information, time information, or source information of the second content.

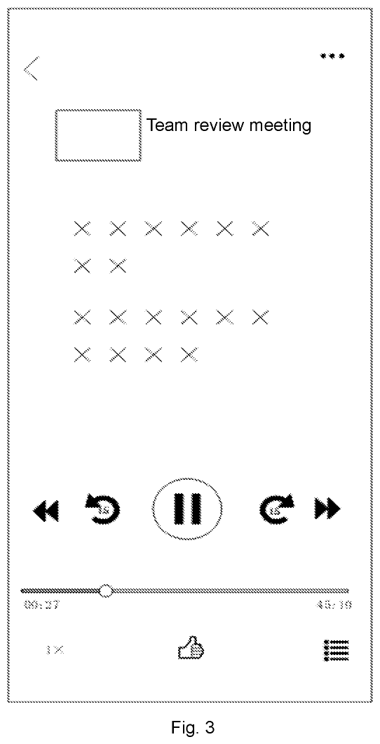

Illustratively, FIG. 3 is an illustrative diagram of a multimedia interface according to embodiments of the present disclosure. As shown in FIG. 3, an illustrative diagram of a second multimedia interface is presented, in which an audio and corresponding subtitle are presented. A time axis of the audio and positions of a plurality of control buttons acting on the audio are shown in FIG. 3 as an example, and a cover picture and a name “team review meeting” of the audio are also presented in the figure.

After the step 203, steps 204-206, steps 207-211, and/or steps 212-216 may be executed, and a specific execution order is not limited, and FIG. 2 is only an example.

At step 204, receiving a play trigger operation on a target audio.

At step 205, playing the target audio, and during playing the target audio, based on timestamps of subtitle sentences included in a target subtitle, emphasizing the subtitle sentences corresponding to a playing progress of the target audio.

Alternatively, the multimedia processing method further comprises: determining a non-silent segment in the target audio; and playing the target audio comprises: only playing the non-silent segment while the target audio is played.

Alternatively, the multimedia processing method further comprises: determining a silent segment and a non-silent segment in the target audio; and playing the target audio comprises: playing the silent segment at a first playing speed, and playing the non-silent segment at a second playing speed, wherein the first playing speed is greater than the second playing speed.

At step 206, in response to an end of playing the target audio, acquiring a next audio associated with the target audio, and switching to play the next audio.

At step 207, receiving an interactive trigger operation of the user in the second multimedia interface.

At step 208, in response to the interactive trigger operation, presenting an interactive component in the second multimedia interface, and acquiring interactive content based on the interactive component.

The interactive component comprises an emoticon component and/or a comment component, and the interactive content comprises an interactive emoticon and/or a comment.

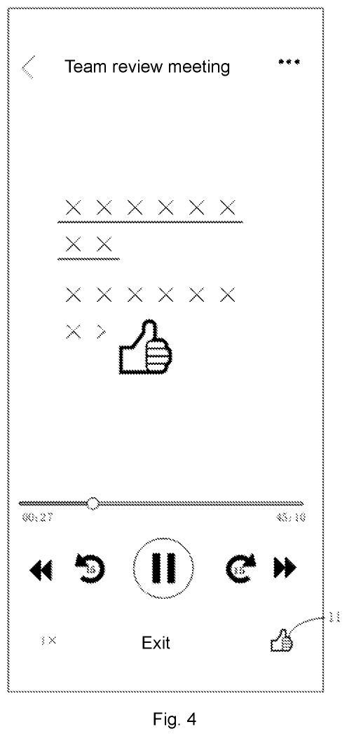

Illustratively, FIG. 4 is an illustrative diagram of another multimedia interface according to embodiments of the present disclosure. As shown in FIG. 4, another schematic diagram of the second multimedia interface is presented in the figure. As compared with FIG. 3, part of contents and positions of buttons in FIG. 4 are different. In FIG. 4, underlined subtitle sentences in the target subtitle characterizes subtitle sentences corresponding to the playing progress of the target audio, and as the target video is played, other subtitle sentences will be also emphasized in an underlining manner. Moreover, an emoticon component 11 in the interactive component is exemplarily presented in the figure, and when the user clicks the emoticon component 11, a default interactive emoticon can be sent and presented in the second multimedia interface, such as “like” in the middle of the interface. Alternatively, when the user clicks the emoticon component 11, an emoticon panel may be also presented, and the emoticon panel may include a plurality of emoticons for the user to select (not shown in the figure). In addition, an exit button is presented below the second multimedia interface in FIG. 4, and when the user triggers the exit button, the user can exit from the second multimedia interface to the first multimedia interface. The second multimedia interfaces presented in FIGS. 3 and 4 are examples and should not be construed as limiting.

At step 209, presenting the interactive content in the second multimedia interface and/or the first multimedia interface.

At step 210, determining an interaction time point corresponding to an interactive input trigger operation.

At step 211, presenting an interactive prompt identification at a position of the interaction time point, on a playing time axis of the target audio in the second multimedia interface and/or the first multimedia interface.

At step 212, receiving an application switching request.

At step 213, switching a first application to background running, and launching a second application, and presenting a presentation interface of the second application.

The first multimedia interface and the second multimedia interface are both interfaces of the first application.

At step 214, presenting a floating window component of the second multimedia interface in the presentation interface of the second application.

Alternatively, the floating window component includes a cover picture and/or playing information of the target audio. Alternatively, the playing information includes a playing progress; and the cover picture and the playing progress are presented in association. Alternatively, there are a plurality of the cover pictures, and the cover picture varies with the playing progress. Alternatively, the playing progress is displayed around the cover picture. Alternatively, the cover picture is determined based on the first content.

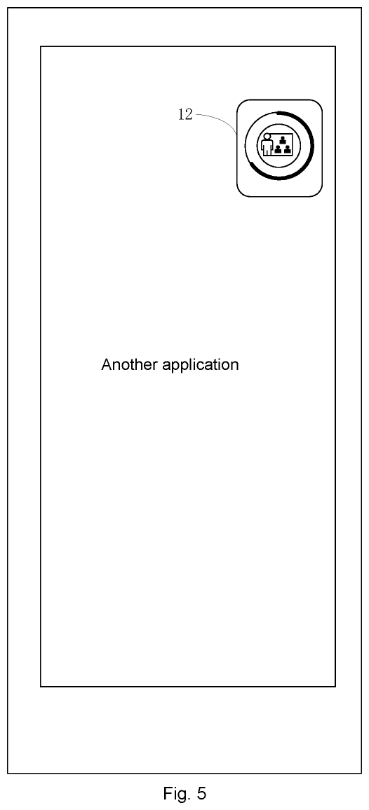

Illustratively, FIG. 5 is an illustrative diagram of a floating window component according to embodiments of the present disclosure. As shown in FIG. 5, a floating window component 12 under another application is presented in the figure, where the another application is the second application, and the floating window component 12 may be disposed in an area, close to a boundary, of a presentation interface of the another application. And the cover picture and the playing progress of the second multimedia interface are also presented in the floating window component 12, a black filling area at an edge of the floating window component in the picture characterizes the playing progress, and the playing progress in the picture is close to two thirds. The floating window component presented in FIG. 5 is merely an example, and other shapes or styles of floating window components may be applicable.

After the step 214, step 215 and/or step 216 may be executed.

At step 215, receiving a trigger operation on the floating window component, switching the first application from background running to foreground running, and returning to presenting the second multimedia interface.

At step 216, continuing playing the target audio based on the floating window component.

Before the step 210 is executed, if the target audio is being played, the target audio may be continuously played based on the floating window component.

In some embodiments, the multimedia processing method may further comprise: receiving a modification operation on the target subtitle presented in the first multimedia interface; and synchronously modifying the target subtitle presented in the second multimedia interface.

The multimedia processing solution according to embodiments of the present disclosure comprises: presenting a first multimedia interface comprising first content; receiving an interface switching request of a user in the first multimedia interface; switching from the first multimedia interface currently presented to a second multimedia interface, and presenting second content in the second multimedia interface; wherein the first content comprises second content and other content associated with the second content, and the second content comprises a target audio and a target subtitle corresponding to the target audio. By adopting the above technical solution, the switching of the interfaces comprising two different contents can be realized, wherein one interface may comprise only audio and subtitle, which helps the user to concentrate on the multimedia content in a complex scene, and improves flexibility of playing the multimedia content, can meet the requirements of various scenes, and further improves the experience effect of the user.

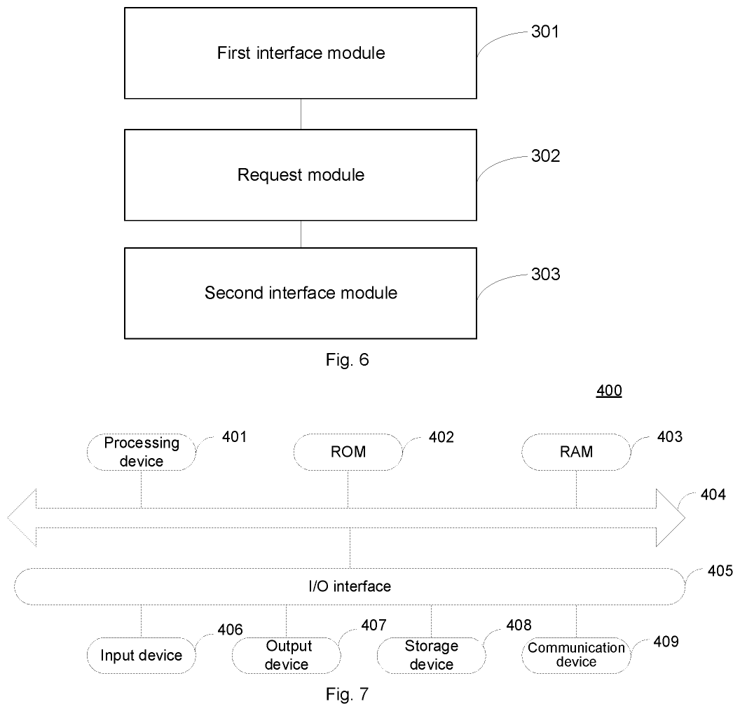

FIG. 6 is an illustrative structural diagram of a multimedia processing apparatus according to embodiments of the present disclosure, where the apparatus may be implemented by software and/or hardware, and may be generally integrated in an electronic device. As shown in FIG. 6, the apparatus comprises: a first interface module 301, configured to present a first multimedia interface comprising first content; a request module 302, configured to receive an interface switching request of a user in the first multimedia interface; and a second interface module 303, configured to switch from the first multimedia interface currently presented to a second multimedia interface, and present second content in the second multimedia interface, wherein the first content comprises the second content and other content associated with the second content, and the second content comprises a target audio and a target subtitle corresponding to the target audio.

Alternatively, the apparatus further comprises a playing module, configured to: receive a play trigger operation on the target audio; and play the target audio, and during playing the target audio, based on timestamps of subtitle sentences included in the target subtitle, emphasize a subtitle sentences corresponding to a playing progress of the target audio.

Alternatively, the playing module is specifically configured to: in response to an end of playing the target audio, acquiring a next audio associated with the target audio, and switching to playing the next audio.

Alternatively, the apparatus further comprises a first audio recognition module configured to determine a non-silent segment in the target audio, and the playing module is specifically configured to only play the non-silent segment when the target audio is played.

Alternatively, the apparatus further comprises a second audio recognition module configured to determine a silent segment and a non-silent segment in the target audio, and the playing module is specifically configured to play the silent segment at a first playing speed, and play the non-silent segment at a second playing speed, wherein the first playing speed is greater than the second playing speed.

Alternatively, the apparatus further comprises an interaction module configured to: receive an interactive trigger operation of the user in the second multimedia interface; and determine interactive content based on the interactive trigger operation.

Alternatively, the interaction module is configured to: in response to the interactive trigger operation, present an interactive component in the second multimedia interface; and acquire the interactive content based on the interactive component, and present the interactive content in the second multimedia interface, wherein the interactive component comprises an emoticon component and/or comment component, and the interactive content comprises an interactive emoticon and/or a comment.

Alternatively, the interaction module is configured to present the interactive content in the first multimedia interface.

Alternatively, the interaction module is configured to: determine an interaction time point corresponding to the interactive input trigger operation; and present an interactive prompt identification at a position of the interaction time point, on a playing time axis of the target audio in the second multimedia interface and/or the first multimedia interface.

Alternatively, the apparatus further comprises a modification module configured to: receive a modification operation on the target subtitle presented in the first multimedia interface; and synchronously modify the target subtitle presented in the second multimedia interface.

Alternatively, the first multimedia interface and the second multimedia interface are both interfaces of a first application, and the apparatus further comprises a floating window module, configured to: receive an application switching request; switch the first application to background running and launching a second application, and presenting a presentation interface of the second application; and presenting a floating window component of the second multimedia interface in the presentation interface of the second application.

Alternatively, the floating window component includes a cover picture and/or playing information of the target audio.

Alternatively, the playing information includes a playing progress; and the cover picture and the playing progress are presented in association.

Alternatively, there are a plurality of the cover pictures, and the cover picture varies with the playing progress.

Alternatively, the playing progress is displayed around the cover picture.

Alternatively, the cover picture is determined based on the first content.

Alternatively, the apparatus further comprises a return module configured to: receive a trigger operation on the floating window component, switch the first application from background running to foreground running, and return to presenting the second multimedia interface.

Alternatively, if the target audio is being played before receiving the application switching request, the floating window module is further configured to: continue to play the target audio based on the floating window component.

Alternatively, the apparatus further comprises a third interface module configured to: in response to an interface switching request of the user in a currently presented third multimedia interface, switch the currently displayed third multimedia interface into the second multimedia interface, wherein the third multimedia interface comprises third content, and the third content comprises attribute information of the second content.

Alternatively, the attribute information of the second content includes at least one of title information, time information, or source information of the second content.

The multimedia processing apparatus according to embodiments of the present disclosure can perform the multimedia processing method provided in any embodiment of the present disclosure, and has corresponding functional modules and beneficial effects of the method performed.

An embodiment of the present disclosure also provides a computer program product, comprising a computer program/instructions, which when executed by a processor, implements the multimedia processing method provided in any embodiment of the present disclosure.

FIG. 7 is an illustrative structural diagram of an electronic device according to embodiments of the present disclosure. Referring now specifically to FIG. 7, an illustrative block diagram of an electronic device 400 suitable for implementing embodiments of the present disclosure is shown. The electronic device 400 in embodiments of the present disclosure may comprise, but is not limited to, a mobile terminal such as a mobile phone, a notebook computer, a digital broadcast receiver, a PDA (personal digital assistant), a PAD (tablet computer), a PMP (portable multimedia player), a vehicle mounted terminal (e.g., a vehicle mounted navigation terminal), and the like, and a fixed terminal such as a digital TV, a desktop computer, and the like. The electronic device shown in FIG. 7 is only an example, and should not bring any limitation to the functions and the scope of use of embodiments of the present disclosure.

As shown in FIG. 7, the electronic device 400 may comprise a processing device (e.g., central processor, graphics processor, etc.) 401 that may perform various appropriate actions and processes in accordance with a program stored in a Read Only Memory (ROM) 402 or a program loaded from a storage device 408 into a Random Access Memory (RAM) 403. In the RAM 403, various programs and data necessary for the operation of the electronic device 400 are also stored. The processing device 401, the ROM 402, and the RAM 403 are connected to each other via a bus 404. An input/output (I/O) interface 405 is also connected to the bus 404.

Generally, the following devices may be connected to the I/O interface 405: an input device 406 including, for example, a touch screen, touch pad, keyboard, mouse, camera, microphone, accelerometer, gyroscope, etc.; an output device 407 including, for example, a Liquid Crystal Display (LCD), a speaker, a vibrator, etc.; a storage devices 408 including, for example, magnetic tape, hard disk, etc.; and a communication device 409. The communication device 409 may allow the electronic device 400 to communicate with other devices, either wirelessly or by wire, to exchange data. While FIG. 7 illustrates an electronic device 400 having various devices, it is to be understood that not all illustrated devices are required to be implemented or provided. More or fewer devices may be alternatively implemented or provided.

In particular, the processes described above with reference to the flow diagrams may be implemented as computer software programs, according to the embodiments of the present disclosure. For example, the embodiments of the present disclosure include a computer program product comprising a computer program carried on a non-transitory computer readable medium, the computer program containing program code for performing the method illustrated by the flow diagram. In such an embodiment, the computer program may be downloaded from a network via the communication device 409 and installed, or installed from the storage device 408, or installed from the ROM 402. The computer program, when executed by the processing device 401, performs the above-described functions defined in the multimedia processing method of the embodiments of the present disclosure.

It should be noted that the above computer-readable medium of the present disclosure may be a computer-readable signal medium or a computer-readable storage medium or any combination of the two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium containing or storing a program which can be used by or in conjunction with an instruction execution system, apparatus, or device. Moreover, in the present disclosure, the computer-readable signal medium may include a data signal propagated in baseband or as part of a carrier wave, in which computer-readable program code is carried. Such a propagated data signal may take a variety of forms, including, but not limited to, electromagnetic signals, optical signals, or any suitable combination of the above. The computer-readable signal medium may also be any computer-readable medium other than the computer-readable storage medium, which can send, propagate, or transmit a program for use by or in conjunction with an instruction execution system, apparatus, or device. The program code contained on the computer-readable medium may be transmitted using any appropriate medium, including but not limited to: wires, optical cables, RF (radio frequency), etc., or any suitable combination of the above.

In some implementations, a client and server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has thereon carried one or more programs which, when executed by the electronic device, cause the electronic device to: present a first multimedia interface comprising first content; receive an interface switching request of a user in the first multimedia interface; switch from the first multimedia interface currently presented to a second multimedia interface, and present second content in the second multimedia interface; wherein the first content comprises the second content and other content associated with the second content, and the second content comprises a target audio and a target subtitle corresponding to the target audio.

Computer program code for performing operations of the present disclosure may be written in one or more programming languages or a combination thereof. The above programming language includes, but is not limited to, an object-oriented programming language such as Java, Smalltalk, and C++, and further includes a conventional procedural programming language such as the “C” language or a similar programming language. The program code may be executed entirely on a user's computer, partly on the user's computer, as a stand-alone software package, partly on the user's computer and partly on a remote computer, or entirely on the remote computer or server. In a scenario where the remote computer is involved, the remote computer may be connected to the user's computer through any type of network, including a local area network (LAN) or a wide area network (WAN), or connected to an external computer (for example, through the Internet using an Internet service provider).

The flow diagrams and block diagrams in the drawings illustrate the possibly implemented architecture, functions, and operations of the systems, methods and computer program products according to various embodiments of the present disclosure. In this regard, each block in the flow diagram or block diagram may represent one module, program segment, or part of code, which contains one or more executable instructions for implementing specified logical functions. It should also be noted that, in some alternative implementations, the functions noted in the blocks may also occur in a different order from those noted in the drawings. For example, two blocks shown in succession may, in fact, be executed substantially concurrently, and they may sometimes be executed in a reverse order, which depends upon functions involved. It will also be noted that each block of the block diagrams and/or flow diagrams, and a combination of blocks in the block diagrams and/or flow diagrams, can be implemented by a special-purpose hardware-based system that performs the specified functions or operations, or a combination of special-purpose hardware and computer instructions.

The involved units described in embodiments of the present disclosure may be implemented by software or hardware. The name of the unit, in some cases, does not constitute a limitation on the unit itself.

The functions described above herein may be at least partially executed by one or more hardware logic components. For example, without limitation, an exemplary type of hardware logic components that may be used includes: a field programmable gate array (FPGA), application specific integrated circuit (ASIC), application specific standard product (ASSP), system on a chip (SOC), complex programmable logic device (CPLD), and the like.

In the context of this disclosure, a machine-readable medium may be a tangible medium, which may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, there is provided a multimedia processing method, comprising: presenting a first multimedia interface comprising first content; receiving an interface switching request of a user in the first multimedia interface; and switching from the first multimedia interface currently presented to a second multimedia interface, and presenting second content in the second multimedia interface, wherein the first content comprises the second content and other content associated with the second content, and the second content comprises a target audio and a target subtitle corresponding to the target audio.

According to one or more embodiments of the present disclosure, in the multimedia processing method according to the present disclosure, the method further comprises: receiving a play trigger operation on the target audio; and playing the target audio, and during playing the target audio, based on timestamps of subtitle sentences included in the target subtitle, emphasizing the subtitle sentences corresponding to a playing progress of the target audio.

According to one or more embodiments of the present disclosure, in the multimedia processing method according to the present disclosure, the method further comprises: in response to an end of playing the target audio, acquiring a next audio associated with the target audio, and switching to play the next audio.

According to one or more embodiments of the present disclosure, in the multimedia processing method according to the present disclosure, the method further comprises determining a non-silent segment in the target audio, and the playing the target audio comprises only playing the non-silent segment when the target audio is being played.

According to one or more embodiments of the present disclosure, in the multimedia processing method according to the present disclosure, the method further comprises: determining a silent segment and a non-silent segment in the target audio; and the playing the target audio comprises: playing the silent segment at a first playing speed, and playing the non-silent segment at a second playing speed, wherein the first playing speed is greater than the second playing speed.

According to one or more embodiments of the present disclosure, in the multimedia processing method according to the present disclosure, the method further comprises: receiving an interactive trigger operation of the user in the second multimedia interface; and determining interactive content based on the interactive trigger operation.

According to one or more embodiments of the present disclosure, in the multimedia processing method according to the present disclosure, the determining interactive content based on the interactive trigger operation comprises: in response to the interactive trigger operation, presenting an interactive component in the second multimedia interface; and acquiring interactive content based on the interactive component, and presenting the interactive content in the second multimedia interface, wherein the interactive component comprises an emoticon component and/or comment component, and the interactive content comprises an interactive emoticon and/or a comment.

According to one or more embodiments of the present disclosure, in the multimedia processing method according to the present disclosure, the method further comprises presenting the interactive content in the first multimedia interface.

According to one or more embodiments of the present disclosure, in the multimedia processing method according to the present disclosure, the method further comprises: determining an interaction time point corresponding to the interactive input trigger operation; and presenting an interactive prompt identification at a position of the interaction time point, on a playing time axis of the target audio in the second multimedia interface and/or the first multimedia interface.

According to one or more embodiments of the present disclosure, in the multimedia processing method according to the present disclosure, the method further comprises: receiving a modification operation on the target subtitle presented in the first multimedia interface; and synchronously modifying the target subtitle presented in the second multimedia interface.

According to one or more embodiments of the present disclosure, in the multimedia processing method according to the present disclosure, the first multimedia interface and the second multimedia interface are both interfaces of a first application, and the method further comprises: receiving an application switching request; switching the first application to background running and launching a second application, and presenting a presentation interface of the second application; and presenting a floating window component of the second multimedia interface in the presentation interface of the second application.

According to one or more embodiments of the present disclosure, in the multimedia processing method according to the present disclosure, the floating window component includes a cover picture and/or playing information of the target audio.

According to one or more embodiments of the present disclosure, in the multimedia processing method according to the present disclosure, the playing information includes a playing progress; and the cover picture and the playing progress are presented in association.

According to one or more embodiments of the present disclosure, in the multimedia processing method according to the present disclosure, there are a plurality of the cover pictures, and the cover picture varies with the playing progress.

According to one or more embodiments of the present disclosure, in the multimedia processing method according to the present disclosure, the playing progress is displayed around the cover picture.

According to one or more embodiments of the present disclosure, in the multimedia processing method according to the present disclosure, the cover picture is determined based on the first content.

According to one or more embodiments of the present disclosure, in the multimedia processing method according to the present disclosure, the method further comprises: receiving a trigger operation on the floating window component, switching the first application from background running to foreground running, and returning to presenting the second multimedia interface.

According to one or more embodiments of the present disclosure, in the multimedia processing method according to the present disclosure, if the target audio is being played before receiving the application switching request, the method further comprises: continuing playing the target audio based on the floating window component.

According to one or more embodiments of the present disclosure, in the multimedia processing method according to the present disclosure, the method further comprises: in response to an interface switching request of the user in a currently presented third multimedia interface, switching the currently displayed third multimedia interface into the second multimedia interface, wherein the third multimedia interface comprises third content, and the third content comprises attribute information of the second content.

According to one or more embodiments of the present disclosure, in the multimedia processing method according to the present disclosure, the attribute information of the second content includes at least one of title information, time information, or source information of the second content.

According to one or more embodiments of the present disclosure, there is provided a multimedia processing apparatus comprising: a first interface module configured to present a first multimedia interface comprising first content; a request module configured to receive an interface switching request of a user in the first multimedia interface; a second interface module configured to switch from the first multimedia interface currently presented to a second multimedia interface and present second content in the second multimedia interface, wherein the first content comprises the second content and other content associated with the second content, and the second content comprises a target audio and a target subtitle corresponding to the target audio.

According to one or more embodiments of the present disclosure, in the multimedia processing apparatus according to the present disclosure, the apparatus further comprises a playing module, configured to: receive a play trigger operation on the target audio; and play the target audio, and during playing the target audio, based on timestamps of subtitle sentences included in the target subtitle, emphasize the subtitle sentences corresponding to a playing progress of the target audio.

According to one or more embodiments of the present disclosure, in the multimedia processing apparatus according to the present disclosure, the playing module is specifically configured to: in response to an end of playing the target audio, acquire a next audio associated with the target audio, and switch to play the next audio.

According to one or more embodiments of the present disclosure, in the multimedia processing apparatus according to the present disclosure, the apparatus further comprises a first audio recognition module configured to determine a non-silent segment in the target audio, and the playing module is specifically configured to only play the non-silent segment when the target audio is played.

According to one or more embodiments of the present disclosure, in the multimedia processing apparatus according to the present disclosure, the apparatus further comprises a second audio recognition module configured to determine a silent segment and a non-silent segment in the target audio, and the playing module is specifically configured to: play the silent segment at a first playing speed, and play the non-silent segment at a second playing speed, wherein the first playing speed is greater than the second playing speed.

According to one or more embodiments of the present disclosure, in a multimedia processing apparatus according to the present disclosure, the apparatus further includes an interaction module configured to: receive an interactive trigger operation of the user in the second multimedia interface; and determine interactive content based on the interactive trigger operation.

According to one or more embodiments of the present disclosure, in the multimedia processing apparatus according to the present disclosure, the interaction module is configured to: in response to the interactive trigger operation, present an interactive component in the second multimedia interface; acquire interactive content based on the interactive component, and present the interactive content in the second multimedia interface; wherein the interactive component comprises an emoticon component and/or comment component, and the interactive content comprises an interactive emoticon and/or a comment.

According to one or more embodiments of the present disclosure, in the multimedia processing apparatus according to the present disclosure, the interaction module is configured to: present the interactive content in the first multimedia interface.

According to one or more embodiments of the present disclosure, in the multimedia processing apparatus according to the present disclosure, the interaction module is configured to: determine an interaction time point corresponding to the interactive input trigger operation; and present an interactive prompt identification at a position of the interaction time point, on a playing time axis of the target audio in the second multimedia interface and/or the first multimedia interface.

According to one or more embodiments of the present disclosure, in the multimedia processing apparatus according to the present disclosure, the apparatus further includes a modification module configured to: receive a modification operation on the target subtitle presented in the first multimedia interface; and synchronously modify the target subtitle presented in the second multimedia interface.

According to one or more embodiments of the present disclosure, in the multimedia processing apparatus according to the present disclosure, the first multimedia interface and the second multimedia interface are both interfaces of a first application, and the apparatus further comprises a floating window module, configured to: receive an application switching request; switch the first application to background running and launching a second application, and presenting a presentation interface of the second application; and present the floating window component of the second multimedia interface in the presentation interface of the second application.

According to one or more embodiments of the present disclosure, in the multimedia processing apparatus according to the present disclosure, the floating window component includes a cover picture and/or playing information of the target audio.

According to one or more embodiments of the present disclosure, in the multimedia processing apparatus according to the present disclosure, the playing information includes a play progress; and the cover picture and the playing progress are presented in association.

According to one or more embodiments of the present disclosure, in the multimedia processing apparatus according to the present disclosure, there are a plurality of the cover pictures, and the cover picture varies with the playing progress.

According to one or more embodiments of the present disclosure, in the multimedia processing apparatus according to the present disclosure, the playing progress is displayed around the cover picture.

According to one or more embodiments of the present disclosure, in the multimedia processing apparatus according to the present disclosure, the cover picture is determined based on the first content.

According to one or more embodiments of the present disclosure, in the multimedia processing apparatus according to the present disclosure, the apparatus further comprises a return module configured to: receive a trigger operation on the floating window component, switch the first application from background running to foreground running, and return to presenting the second multimedia interface.

According to one or more embodiments of the present disclosure, in the multimedia processing apparatus according to the present disclosure, if the target audio is being played before receiving the application switching request, the floating window module is further configured to: continue to play the target audio based on the floating window component.

According to one or more embodiments of the present disclosure, in the multimedia processing apparatus according to the present disclosure, the apparatus further comprises a third interface module configured to: in response to an interface switching request of the user in a currently presented third multimedia interface, switch the currently presented third multimedia interface into the second multimedia interface, wherein the third multimedia interface comprises third content, and the third content comprises attribute information of the second content.

According to one or more embodiments of the present disclosure, in the multimedia processing apparatus according to the present disclosure, the attribute information of the second content includes at least one of title information, time information, or source information of the second content.

According to one or more embodiments of the present disclosure, there is provided an electronic device comprising: a processor; and a memory configured to store instructions executable by the processor, wherein the processor is configured to read the executable instructions from the memory and execute the instructions to implement any of the multimedia processing method provided in the present disclosure.

According to one or more embodiments of the present disclosure, there is provided a computer-readable storage medium, having stored thereon a computer program for performing any of the multimedia processing method provided in the present disclosure.

The foregoing description is only illustrations of preferred embodiments of the present disclosure and the technical principles employed. It should be appreciated by those skilled in the art that the scope involved in the present disclosure is not limited to the technical solutions formed by specific combinations of the technical features described above, but also encompasses other technical solutions formed by arbitrary combinations of the above technical features or equivalent features thereof without departing from the above disclosed concepts. For example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Conversely, the specific features and actions described above are only example forms of implementing the claims.

1. A multimedia processing method, comprising:
presenting a first multimedia interface comprising first content;
receiving an interface switching request of a user in the first multimedia interface; and
switching from the first multimedia interface currently presented to a second multimedia interface, and presenting second content in the second multimedia interface,
wherein the first content comprises the second content and other content associated with the second content, and the second content comprises a target audio and a target subtitle corresponding to the target audio.

2. The method of claim 1, further comprising:
receiving a play trigger operation on the target audio; and
playing the target audio and emphasizing a subtitle sentence included in the target subtitle corresponding to a playing progress of the target audio during playing the target audio, based on a timestamp of the subtitle sentence.

3. The method of claim 2, further comprising:
acquiring a next audio associated with the target audio, and switching to play the next audio, in response to an end of playing the target audio.

4. The method of claim 2, further comprising:
determining a non-silent segment in the target audio,
wherein the playing the target audio comprises only playing the non-silent segment when the target audio is being played.

5. The method of claim 2, further comprising:
determining a silent segment and a non-silent segment in the target audio,
wherein the playing the target audio comprises playing the silent segment at a first playing speed, and playing the non-silent segment at a second playing speed, and wherein the first playing speed is greater than the second playing speed.

6. The method of claim 1, further comprising:
receiving an interactive trigger operation of the user in the second multimedia interface; and
determining interactive content based on the interactive trigger operation.

7. The method of claim 6, wherein the determining the interactive content based on the interactive trigger operation comprises:
presenting an interactive component in the second multimedia interface, in response to the interactive trigger operation;
acquiring the interactive content based on the interactive component, and presenting the interactive content in the second multimedia interface,
wherein the interactive component comprises at least one of an emoticon component or a comment component, and the interactive content comprises at least one of an interactive emoticon or a comment.

8. The method of claim 6, further comprising:
presenting the interactive content in the first multimedia interface.

9. The method of claim 6, further comprising:
determining an interaction time point corresponding to the interactive trigger operation; and
presenting an interactive prompt identification at a position of the interaction time point on a playing time axis of the target audio in at least one of the second multimedia interface or the first multimedia interface.

10. The method of claim 1, further comprising:
receiving a modification operation on the target subtitle presented in the first multimedia interface; and
synchronously modifying the target subtitle presented in the second multimedia interface.

11. The method of claim 1, wherein the first multimedia interface and the second multimedia interface are both interfaces of a first application, and the method further comprises:
receiving an application switching request;
switching the first application to background running and launching a second application, and presenting a presentation interface of the second application; and
presenting a floating window component of the second multimedia interface in the presentation interface of the second application.

12. The method of claim 1, further comprising:
receiving a return operation of the user in the second multimedia interface; and
returning to presenting the first multimedia interface, and presenting in the first multimedia interface a floating window component of the second multimedia interface.

13. The method of claim 11, wherein the floating window component includes at least one of a cover picture or playing information of the target audio.

14. The method of claim 13, wherein the playing information includes a playing progress, and the cover picture and the playing progress are presented in association.

15. The method of claim 14, wherein:
there are a plurality of the cover pictures, and the cover picture varies with the playing progress; or
the playing progress is displayed around the cover picture.

16. (canceled)

17. The method of claim 13, wherein the cover picture is determined based on the first content.

18. The method of claim 11, further comprising at least one of:
continuing playing the target audio based on the floating window component; or
receiving a trigger operation on the floating window component, and returning to presenting the second multimedia interface.

19. (canceled)

20. The method of claim 1, further comprising:
switching from a third multimedia interface currently displayed to the second multimedia interface, in response to an interface switching request of the user in the third multimedia interface currently presented,
wherein the third multimedia interface comprises third content, and the third content comprises attribute information of the second content, and
wherein the attribute information of the second content includes at least one of title information, time information, or source information of the second content.

21. (canceled)

22. (canceled)

23. An electronic device comprising:
a processor; and
a memory configured to store instructions executable by the processor,
wherein the processor is configured to read the instructions from the memory and execute the instructions to:
present a first multimedia interface comprising first content;
receive an interface switching request of a user in the first multimedia interface; and
switch from the first multimedia interface currently presented to a second multimedia interface, and present second content in the second multimedia interface,
wherein the first content comprises the second content and other content associated with the second content, and the second content comprises a target audio and a target subtitle corresponding to the target audio.

24. A non-transitory computer-readable storage medium, having stored thereon a computer program for performing operations comprising:
presenting a first multimedia interface comprising first content;
receiving an interface switching request of a user in the first multimedia interface; and
switching from the first multimedia interface currently presented to a second multimedia interface, and presenting second content in the second multimedia interface,
wherein the first content comprises the second content and other content associated with the second content, and the second content comprises a target audio and a target subtitle corresponding to the target audio.

25. (canceled)

26. (canceled)
